(19) United States
(12) Patent Application Publication
(10) Pub. No.: US 2006/0221804 A1
(43) Pub. Date: Oct. 5, 2006

(54) Optical recording medium and defect management device and method therefor

(75) Inventor: Toshio Kuroiwa, Yokohama-shi (JP)

Correspondence Address: NATH & ASSOCIATES PLLC, 112 South West Street, Alexandria, VA, 22314, US

(73) Assignee: Victor Company of Japan, Limited, Yokohama-shi (JP)

(21) Appl. No.: 11/390,149

(22) Filed: Mar. 28, 2006

(30) Foreign Application Priority Data
Mar. 29, 2005 (JP) P2005-096127

(51) Int. Cl. G11B 7/24

(52) U.S. Cl. 369/275.3

(57) ABSTRACT

A defect management device comprises a temporary storage buffer unit temporarily storing therein a recording management table including area allocation information used for writing optical recording data in a user data area of an optical recording medium and defect information used for performing defect management processing; a defect detection unit that detects a defect; a defect information creation unit that creates defect information when the defect detection unit detects the detect; an allocation information creation unit that creates area allocation information; a recording management table writing unit that writes a recording management table from the temporary storage buffer unit into a management area; and a recording management table reading unit that reads a latest recording management table on the optical recording medium.

### BACKGROUND OF THE INVENTION

1. Field of the Invention

The present invention relates to the recording/reproduction processing of digital data on an optical recording medium, and more particularly to an optical recording medium and a defect management device and method for managing the defects of digital data on the optical recording medium.

2. Description of the Related Art

Optical discs used widely today are classified roughly into three types. The first is a ROM type disc from which data can only be read. This type of optical disc is used as a distribution medium of music and videos, and its representative example is a CD (Compact Disc) and a DVD-ROM (Digital Versatile Disc ROM). The second is an RW type disc to or from which data can be written or read (recorded or played back) repeatedly. This type of optical disc is used primarily by individual users for recording broadcasts, and its representative example is a DVD-RAM and a DVD-RW (rewritable). The third is an R type disc to which data can be written once. The R type disc is sometimes called a WORM type disc that is an abbreviation of Write Once Read Many. The R type disc, lower in cost as compared with an RW type disc, is used widely for saving video information, and its representative example is a CD-R (Recordable) and a DVD-R.

Data recorded on any of the above media can be read by focusing a laser beam from an optical pickup, built in the drive for playing back the disc, onto the disc surface and then interpreting the reflected beam. When reading data from an optical disc, data written on the disc is sometimes read incorrectly. Such an error is generated by a cause that arises during the manufacture, for example, the material of the recording layer is uneven, by a cause that arises after the manufacture, for example, the laser beam is scattered because of a scratch or a contamination on the disc surface, or by deterioration in the recording material that is caused by repeated recording. A position where an error occurs frequently is called generically as a “defect”.

To avoid a read error, an error correction technology is essential that writes data as a correction code when the data is written and performs the error correction operation when the data is read. To keep the error correction rate sufficiently low for a long time over the whole area of a disc, defect management is necessary to prevent data from being written in a defective area.

The following describes an example of conventional defect management. FIG. 1 is a diagram showing an example of the format of a recording-type optical disc having the areas divided with consideration for defect management. Referring to FIG. 1, the disc is divided into a management area in which the defect management table is stored, a user data area in which data to be reproduced is recorded, and a spare area in which alternate blocks that will be used for defective blocks are stored. The range accessible by a user-specified logical address is limited to the user data area.

When defective blocks X, Y, Z are detected in the user data area, copies of the blocks X, Y, Z are recorded into alternate blocks E, F, G in the spare area and the physical addresses of the defective blocks and the alternate blocks are described in the defect management table in the management area to update the table.

However, this conventional defect management method requires a spare area to be allocated in advance. The problem with this method is that the apparent disc recording capacity is decreased as a larger space area is allocated.

To solve this problem, a method is proposed in which no space area is allocated and logical address conversion is performed to use an R type disc as an apparent RW type disc to allow an alternate block to be allocated directly in the user data area (see Japanese Patent Laid-Open Publication No. 2000-105980). In this method, the file system software installed in the host computer and the drive control circuit included in the drive work together to perform logical address conversion.

An example of data allocation on an R type disc is as shown in FIG. 2. The file identification information is composed of a file name, the start logical address of the file area information, and the number of logical blocks of the file area information, as shown in FIG. 3A. In addition, as shown in FIG. 3B, the file area information is composed of a file size, the number of file areas of the file, and the pairs each composed of the start logical address of a file area and its file area size, one pair for each file area.

Assume that one file composed of three file areas, A, B, and C, is recorded, as shown in (a) in FIG. 2. The file system software in the host computer can read a logical block in the file by reading the information in the following sequence: file identification information, file area information “a”, and file area. To change the contents of file area B, the host computer first reads the whole of file area B and changes the data in that area. After that, the host computer calculates a logical block, in which data can be written, based on an unrecorded area on the disc identifiable by the file system software, and writes the changed data to the disc. In (b) in FIG. 2, the host computer records the changed data on the disc as file area D.

However, to include file area D instead of file area B as a component of the file, the file area information must also be updated. To do so, the host computer creates file area information, which specifies file areas A, D, and C, and writes the created file area information in a free area available for writing (see file area information “b” in (b) in FIG. 2). In addition, as shown in FIG. 3C, the host computer creates an address conversion table describing a pair of logical addresses—a before-conversion logical address at which file area information “a” shown in (a) in FIG. 2 is stored and an after-conversion logical address at which file area information “b” is stored—and writes the created address conversion table in a free area available for writing.

To perform the data read operation thereafter, the drive control circuit detects the address conversion table in advance and changes a read access to a before-conversion logical address, described in the table, to a read access to an after-conversion logical address.

A disc, even if an RW type disc, has sometimes characteristics that the error rate increases relatively rapidly because of deterioration in the recording material caused by repeated recording in the same block. The method described above is sometimes used for such a disc even if the disc is an RW type disc (Japanese Patent Laid-Open Publication No. 2000-105980).

The method disclosed in Japanese Patent Laid-Open Publication No.2000-105980 achieves the object of maximizing the user data area. However, because a physical address in which an alternate block is recorded is already mapped to a logical address, it is necessary to notify the logical address to the file system software to create information as file system data, indicating that the logical address should not be used for recording thereafter, and to record the data on the disc.

The method for using an R type disc as an apparent RW type disc has a problem that much file system data must be created and written on a disc and, in addition, the logical address of a file area must be changed.

### SUMMARY OF THE INVENTION

In view of the foregoing, it is an object of the present invention to provide an optical recording medium and a defect management device and method therefor that reduces the load of the file system software and allows an R type disc to be treated more like an RW type disc.

To archive the above objects, there is provided an optical recording medium comprising: a user data area having a plurality of blocks in which optical recording data is recorded; and a management area storing therein a recording management table including at least one of area allocation information and defect information, the area allocation information used for writing the optical recording data in the user data area, the defect information used for performing defect management processing in the user data area, wherein the area allocation information includes at least type information indicating that the information is the allocation information, an allocated physical address indicating a start block of written information, a logical address of the user data area corresponding to the allocated physical address, and a length of the blocks in which the data is written and the defect information includes at least type information indicating that the information is the defect information, a defective physical address indicating a start block of a defect, an alternate physical address that is an address used when an area indicated by the defective physical address is replaced by another area in the user data area, and a length of the blocks replaced by the alternate area.

To achieve the above objects, there is provided a defect management device for an optical recording medium, comprising: a temporary storage buffer unit temporarily recording therein a recording management table including at least one of area allocation information and defect information, the area allocation information used for writing optical recording data in a user data area having a plurality of blocks of an optical recording medium in which the optical recording data is recorded, the defect information used for performing defect management processing in said user data area; a defect detection unit that detects a defect consisting of at least one defective block in the user data area on the optical recording medium; a defect information creation unit that, when the defect detection unit detects the defect, creates, as the defect information, at least type information indicating that the information is the defect information, a defective physical address indicating a start block of the defect, an alternate physical address that is an address used when an area indicated by the defective physical address is replaced by another area in the user data area, and a length of the blocks replaced by the alternate area, and supplies the created defect information to the temporary storage buffer unit; an allocation information creation unit that creates, as the area allocation information, at least type information indicating that the information is the allocation information, an allocated physical address indicating a start block of written information, a logical address of the user data area corresponding to the allocated physical address, and a length of the blocks in which the data is written, and supplies the created area allocation information to the temporary storage buffer unit; a recording management table writing unit that writes the recording management table, temporarily stored in the temporary storage buffer unit, into the management area on the optical recording medium; and a recording management table reading unit that reads a latest recording management table, written in the management area on the optical recording medium, and temporarily stores the recording management table into the temporary storage buffer unit.

To achieve the above objects, there is provided a defect management method of managing a defect on an optical recording medium including a user data area having a plurality of blocks in which optical recording data is recorded, and a management area storing a record management table including at least one of area allocation information and defect information, the area allocation information used for writing data in the user data area, the defect information used for performing defect management processing in the user data area, the method comprising: detecting a defect consisting of at least one defective block in the user data area on the optical recording medium; reading the recording management table from the management area according to the detection of the defect; storing the recording management table temporarily into a temporary storage buffer unit; searching for another area for storing optical recording data recorded on an area corresponding to the defect in the user data area; recording the optical recording data recorded on the area corresponding to the defect into the another area in the user data area; creating, as the defect information, at least type information indicating that the information is the defect information, a defective physical address indicating a start block of the defect, an alternate physical address that is an address used when an area indicated by the defective physical address is replaced by the another area in the user data area, and a length of the blocks replaced by the alternate area; updating the recording management table in the temporary storage buffer unit by adding the created defect information to the recording management table; and recording the recording management table stored temporarily in the temporary storage buffer unit into the management area on the optical recording medium.

The optical recording medium and the defect management device and method therefor according to the present invention enables defective data to be written in an alternate area, and a file to be partially updated, without adding processing load to the file system. In addition, an R type disc can be treated as an apparent RW type disc without adding processing load to the file system.

### BRIEF DESCRIPTION OF THE DRAWINGS

In the accompanying drawings:

FIG. 1 is a diagram showing the address structure of a conventional optical disc;

FIG. 2 is a diagram showing the address structure of a conventional optical disc;

FIGS. 3A-3C are diagrams showing the data structure of a conventional recording management table;

FIG. 4 is a diagram showing the configuration of a defect management device for an optical recording medium in an embodiment of the present invention;

FIG. 5 is a diagram showing the data structure of an optical disc;

FIG. 6 is a diagram showing the data structure of a recording management table;

FIG. 7 is a diagram showing the data structure of an updated recording management table;

FIG. 8 is a diagram showing the address structure of an optical disc;

FIG. 9 is a flowchart showing the defect management operation of the defect management device for the optical recording medium;

FIG. 10 is a diagram showing the address structure of an optical disc;

FIG. 11 is a diagram showing the data structure of an updated recording management table; and

FIG. 12 is a flowchart showing the file partial update operation of the defect management device.

### DESCRIPTION OF THE PREFERRED EMBODIMENTS

An optical recording medium and a defect management device and method therefor in an embodiment of the present invention will be described below. It should be noted that the devices and the methods used in the embodiment of the present invention are exemplary only and that the present invention is not limited to them.

(Defect Management Device for an Optical Recording Medium)

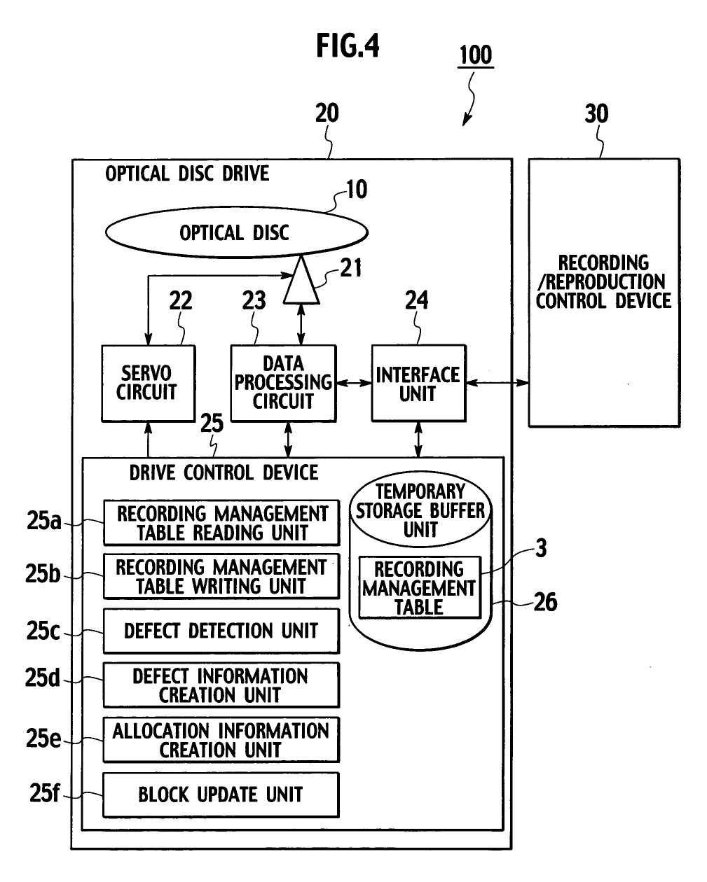

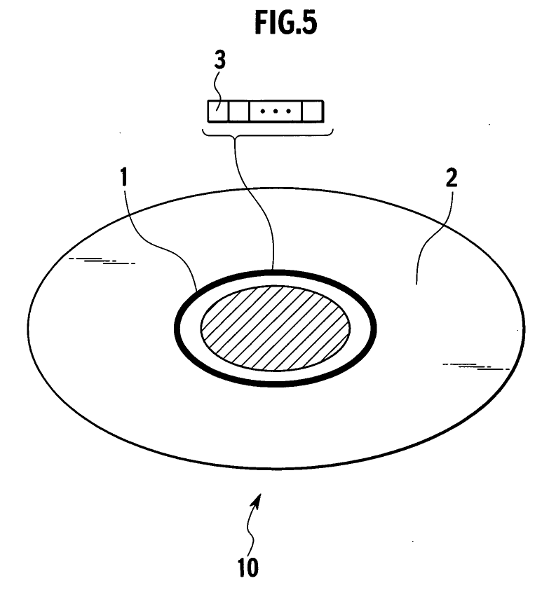

As shown in FIG. 4, a defect management device 100 for an optical recording medium in an embodiment of the present invention comprises an optical disc 10 that is an optical recording medium, an optical disc drive 20 that records and reproduces data to and from the optical disc 10, and a recording/reproduction control device 30 that controls the recording/reproduction processing and the defect management processing of the data.

(Optical Disc)

The optical disc 10 is an R type or an RW type optical recording medium. As shown in FIG. 5, the optical disc 10 comprises a management area 1 allocated in the inner side of the optical disc 10 to record (store) management information specific to the medium and a user data area 2 allocated in the outer side of the management area 1 to record user-desired text data, video data, and music data. For an R type optical recording medium, data can be written in the user data area 2 in the write-once mode, that is, data is written in the same area only once; for an RW type optical recording medium, data can be written in or erased from the user data area 2 any number of times.

On the optical disc 10, the addresses for determining recording positions, generally called physical addresses, are recorded in the sectors (blocks) in advance over the whole recording surface. In contrast, the addresses set up for the file system later by the recording/reproduction control device 30, which will be described later, are called logical addresses.

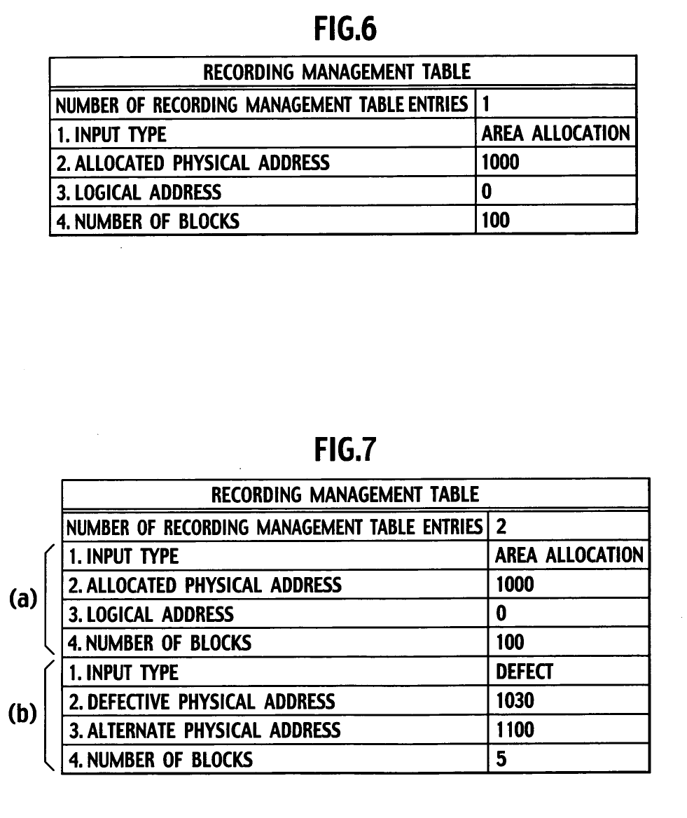

Each time data is recorded, a recording management table 3 is written in the management area 1. In the write-once mode, the recording management table 3 is composed as shown in FIG. 6. That is, the first row contains the number of recording management table entries and, beginning in the next row, the following items are recorded: 1. input type, 2-3. paired physical address and logical address, and 4. number of blocks. The row representing the number of recording management table entries contains the number of entered recording management tables. The row representing the input type contains the type of the entered recording management table 3. The input type, one-bit information, is “0” to indicate area allocation, or “1” to indicate a defect on the disc. The rows representing the paired physical address and logical address contain an allocated physical address and a logical address in FIG. 6. The allocated physical address is the start address of the allocated physical addresses, and the logical address is the start address of the allocated logical addresses. The row representing the number of blocks contains the number of allocated logical addresses, that is, a value indicating the size of the allocated area. This item is provided to enable an area or a defect to be represented by one entry even if the area or the defect extends across a plurality of blocks.

When updating the recording management table 3, the table need not always be overwritten but an updated recording management table 3 may also be added. When reading the recording management table 3, the table at the highest physical address is read to obtain the latest table.

Next, when the recording management table 3 is updated to enter defect information, the number of recording management table entries is incremented by 1 to “2” as shown in (a) in FIG. 7. Because the defect information is entered, “Defect” is entered in the row representing “1. input type” as shown in (b) in FIG. 7. The rows representing “2-3. paired physical address and logical address” contain the start address of the physical addresses in which the defect is detected and the start address of the physical addresses of alternate blocks in which data is recorded, respectively. The row representing “4. number of blocks” is “5” indicating the number of defective blocks.

In this way, each time recorded data is updated or defect processing is performed, the recording management table 3 is stored in the management area 1.

(Optical Disc Drive)

As shown in FIG. 4, the optical disc drive 20 comprises an optical pickup 21 that focuses a laser beam on the optical disc 10, a servo circuit 22 that controls the position of the optical pickup 21 for recording and reproduction, a data processing circuit 23 that applies an error correction code processing to, and digitally modulates, data to be recorded or reproduced, an interface unit 24 that converts data to be recorded or reproduced into a form interpretable by the recording/reproduction control device 30, and a drive control device 25 that controls the optical disc drive 20.

As shown in FIG. 4, the drive control device 25 comprises a recording management table reading unit 25a, a recording management table writing unit 25b, a defect detection unit 25c, and a defect information creation unit 25d, an allocation information creation unit 25e, a block update unit 25f, and a temporary storage buffer unit 26.

The temporary storage buffer unit 26 is a memory in which the recording management table 3 in the management area 1 of the optical disc 10 is recorded temporarily. The recording management table reading unit 25a reads the latest recording management table 3 from the management area 1 of the optical disc 10 and stores it temporarily in the temporary storage buffer unit 26. The recording management table writing unit 25b writes the recording management table 3, updated in the temporary storage buffer unit 26, into the management area 1 of the optical disc 10.

The defect detection unit 25c detects defective data (any defective block) in the user data area 2 on the optical disc 10 via the data processing circuit 23 when the disc is played back. The defect information creation unit 25d creates defect information on a detected defect and updates the recording management table 3 in the temporary storage buffer unit 26. The allocation information creation unit 25e creates area allocation information for adding data to the optical disc 10 and updates the recording management table 3 in the temporary storage buffer unit 26. The block update unit 25f converts a recording start logical address, specified by the recording/reproduction control device 30, to an appropriate physical address based on the defect information or the area allocation information to determine the optical pickup position, controls the time at which the recording starts, and updates the block. This address conversion is performed usually by a simple method; for example, a predetermined offset value is added.

(Recording/Reproduction Control Device)

The recording/reproduction control device 30 is file system software that searches the optical disc for a position where data can be written, assigns a name to a collection of written data for managing it as a file, provides the folder function for storing multiple files as a collection of files, and manages the hierarchical relation among multiple folders. The recording/reproduction control device 30 controls the optical disc drive 20 according to a user-specified instruction when the optical disc drive 20 performs data recording/reproduction processing and defect management processing of the optical disc 10.

The recording/reproduction control device 30 treats the optical disc drive 20, on which a recording type optical disc 10 is loaded, as a string of recording blocks to and from which data can be written and read, and specifies each recording block using a numeric value called a logical address. Not only the optical disc drive 20 but also a recording (storage) device (not shown), such as a hard disk drive, is connected to the recording/reproduction control device 30 via the interface standard common to the optical disc drive 20. This interface standard defines a method for use by the recording/reproduction control device 30 to issue commands such as a read command or a write command, as well as the read/write start logical address and the number of transfer blocks, to the optical disc drive 20 and the protocol for transferring recording/reproduction data. To allow an R type optical disc to be treated as an RW type optical disc, the recording/reproduction control device 30 works together with the drive control device 25 when data is recorded on an R type or RW type disc to convert a logical address to make it correspond to a physical address on the optical disc 10.

When data is recorded on the optical disc 10, the recording/reproduction control device 30 first determines the write start logical address and the number of blocks to be written, issues the write command to the drive control device

and, after that, sends recording data. The drive control device 25 receives the recording data via the interface unit 24, uses the data processing circuit 23 to apply an error correction code processing to the data and modulate it, and drives the optical pickup to write the data.

(Defect Management Method for an Optical Recording Medium)

The defect management device 100 for the optical recording medium performs two types of operation: data defect management processing and file partial update processing. The data defect management processing is performed during the defect management processing for an RW type disc. This is because, for an RW type disc where the same area in the user data area 2 can be rewritten, defect position information must be written in the recording management table 3 to prevent data from being written again in a position where a defect is detected. For an R type disc, the processing described below is not necessary because the user data area 2 cannot be rewritten.

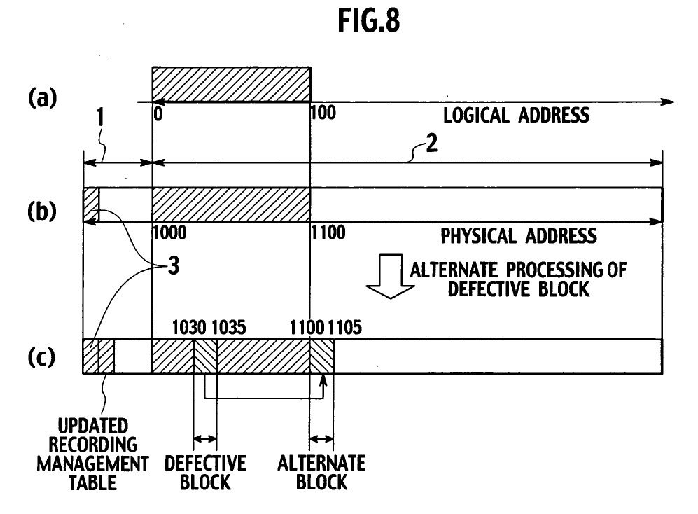

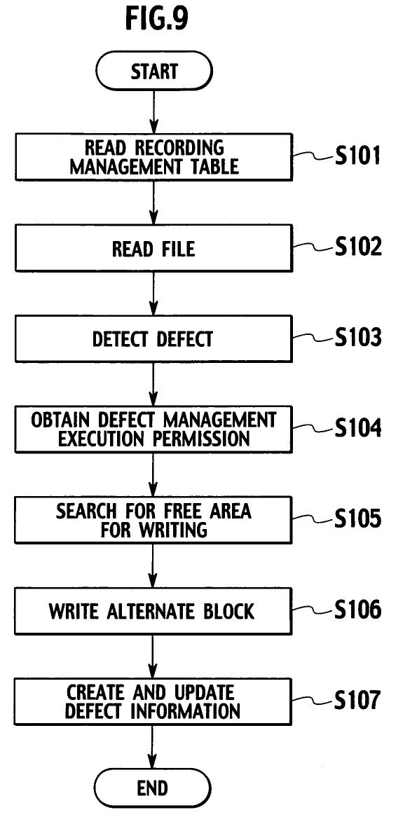

First, the following describes the data detect management processing. Assume that a file composed of 100 blocks is now recorded in logical addresses 0-99 on the optical disc 10 as shown in (a) in FIG. 8. In this case, the file data is continuously written in physical addresses 1000-1099 on the optical disc 10 as shown in (b) in FIG. 8. At this time, one recording management table 3 is recorded in the management area 1, and the recording management table 3 is filled in as shown in FIG. 6. The following describes the operation of the data defect management processing with reference to the flowchart in FIG. 9.

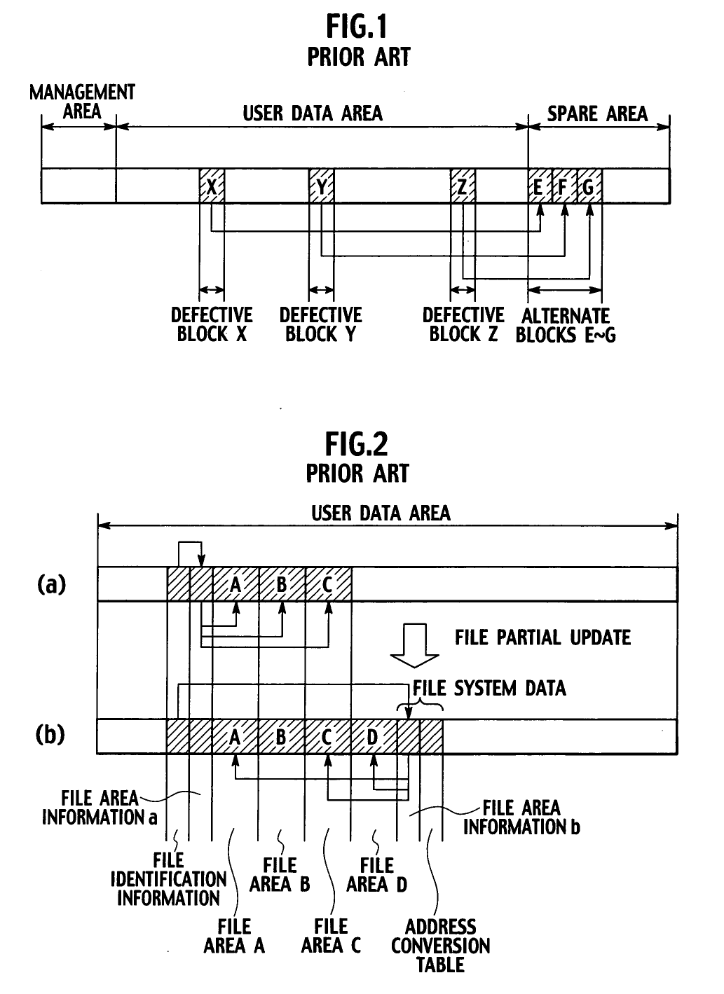

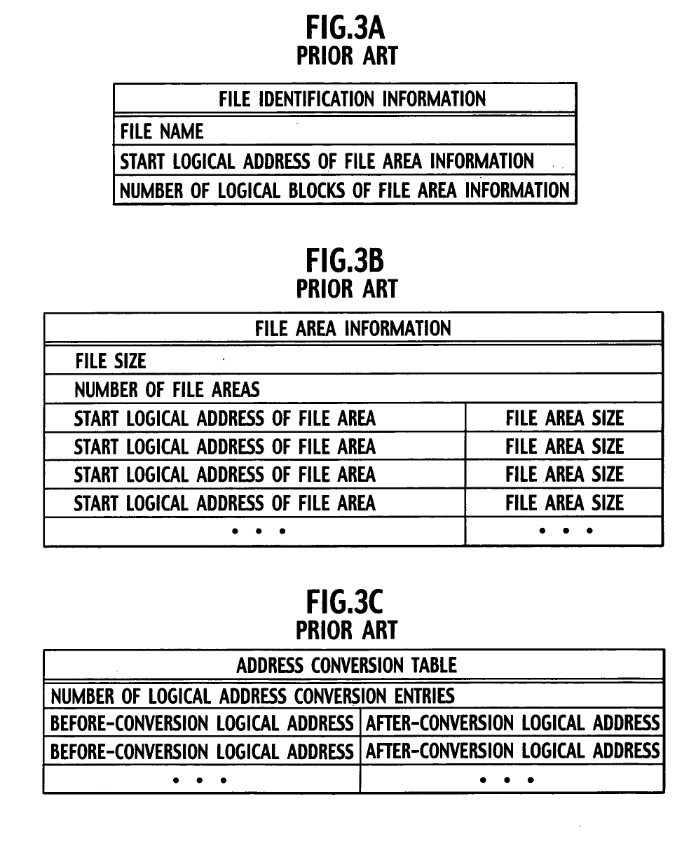

(a) First, in step S101, the recording management table reading unit 25a of the drive control device 25 in FIG. 1 reads the current (latest) contents of the recording management table 3 (see FIG. 6) from the management area 1 on the optical disc 10 and temporarily stores them into the temporary storage buffer unit 26. In step S102, the file in logical addresses 0-99 on the optical disc 10 in (a) in FIG. 8 is read in response to an instruction from the recording/reproduction control device 30.

(b) In step S103, assume that the data processing circuit 23 detects an error while reading the file from the user data area 2 on the optical disc 10. The data processing circuit 23 notifies the error correction information to the drive control device 25. The defect detection unit 25c of the drive control device 25 detects the defect data (any defective block) using the notified error correction information. For example, as shown in (c) in FIG. 8, assume that a defect is detected in five blocks beginning at physical address 1030.

(c) In step S104, after the data processing circuit 23 completes reading the file, the drive control device 25 requests the recording/reproduction control device 30 to give defect management execution permission. The recording/reproduction control device 30 displays the permission to allow the user to browse it, prompts the user to determine whether to give the permission and, if the defect management execution permission is given, notifies the permission to the drive control device 25.

(d) If the defect management execution permission is obtained in step S105, the block update unit 25f searches for a free area in which an alternate block, created by correcting the defect in the defective block, can be written. This area is calculated based on the allocated physical address and the number of blocks in the previously read recording management table 3. Because the allocated physical address is 1000 and the number of blocks is 100 in FIG. 6, the block update unit 25f searches for a five-block alternate block area beginning at the physical address 1100.

(e) In step S106, the defect information creation unit 25d reads the five defective blocks, beginning at the physical address 1030, into the temporary storage buffer unit 26 and writes the alternate blocks, created by correcting the defective blocks, in the area beginning at the physical address 1100, as shown in (c) in FIG. 8. In step S107, the defect information creation unit 25d creates defect information corresponding to those defective blocks, updates the recording management table 3, and writes the updated recording management table 3 in the management area 1 on the optical disc 10 (see (b) in FIG. 7). The recording management table 3 is updated by adding the defect information to the existing information. Specifically, the input type “Defect”, the defect physical address and the alternate physical address, and the defective block length (number of blocks) are added in the table. The added defect information in (b) in FIG. 7 is stored after the previous recording management table 3 as an updated recording management table as shown in (c) in FIG. 8.

By adding the defect information to the recording management table 3 as described above, an access to the physical blocks 1030-1034 in the subsequent read operation is replaced by an access to the physical blocks 1100-1104 to avoid reading the defective blocks. In this case, the drive control device 25 performs alternate processing based on the physical addresses with no change in the logical addresses. This eliminates the need for the recording/reproduction control device 30 to perform special processing for the file system software operation. Therefore, the file system software in the recording/reproduction control device 30 can be reduced in size.

Next, the following describes the file partial update processing of the defect management device 100 for the optical recording medium. The file partial update processing is performed when the defect management processing is performed for an R type disc or when file data is added to an R type or RW type disc. Unlike the defect management processing for an RW type disc described above, new data is added to the user data area 2 and therefore defects need not be considered.

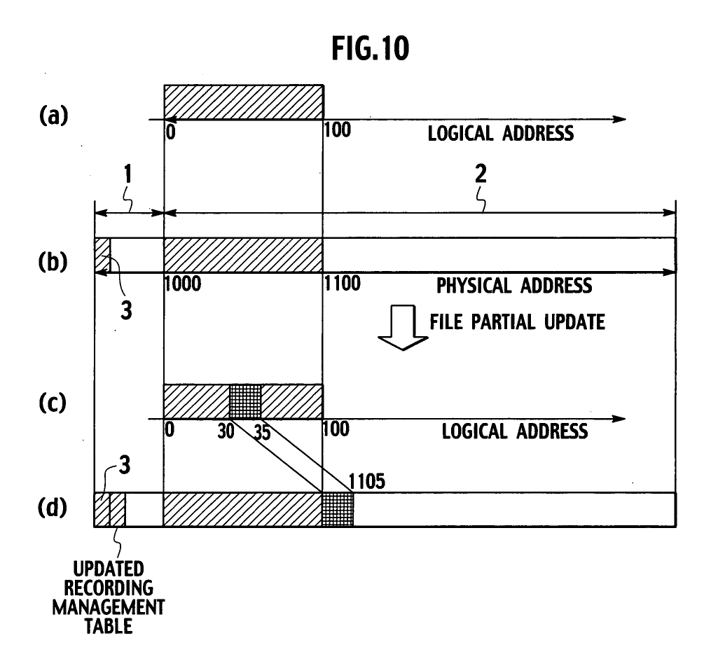

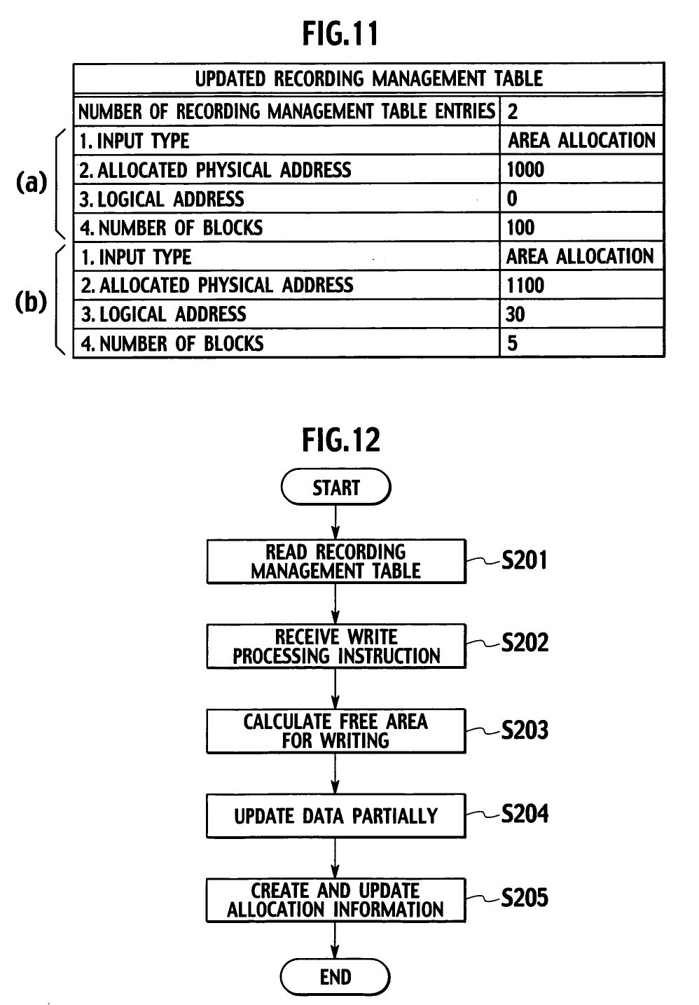

Assume that a file composed of 100 blocks is recorded in the logical addresses 0-99 on the optical disc 10 as shown in (a) in FIG. 10. At this time, the file data is recorded continuously from the physical address 1000 to the physical address 1099 on the optical disc 10 as shown in (b) in FIG. 10. One recording management table 3 is recorded in the management area 1, and the recording management table 3 is filled in as shown in (a) in FIG. 11. With reference to the flowchart in FIG. 12, the following describes the operation of the recording/reproduction control device 30 that reads the logical blocks 30-34 in (c) in FIG. 10, adds changes to the data, and writes the data back into the same logical blocks.

(a) First, in step S201, the recording management table reading unit 25a of the drive control device 25 in FIG. 4 reads the current (latest) contents of the recording management table 3 (see (a) in FIG. 11) from the management area 1 on the optical disc 10 and temporarily stores it into the temporary storage buffer unit 26.

(b) In step S202, the drive control device 25 receives a processing instruction to write five blocks from the recording/reproduction control device 30. In step S203, the block update unit 25f calculates a free area in which those five blocks are to be written. To calculate the area, the block update unit 25f references the previously read recording management table 3 and, in the example in (a) in FIG. 11, determines a five-block area, beginning at the physical address 1100, as a free area for writing.

(c) In step S204, the block update unit 25f records the data, transferred from the recording/reproduction control device 30 for file partial updating, in the five blocks, beginning at the physical address 1100, on the optical disc 10.

(d) In step S205, the allocation information creation unit 25e creates allocation information corresponding to this file partial update recording and, based on the created allocation information, updates the recording management table 3 in the management area 1 on the optical disc 10. For example, as shown in (b) in FIG. 11, the input type “Area allocation”, the allocated physical address 1100, the corresponding logical address 30, and the number of recording blocks 5 are newly entered in the table. The area allocation information added in FIG. 11 is stored after the previous recording management table 3 as an updated recording management table as shown in (d) in FIG. 10.

After the allocation information is added to the recording management table 3 as described above, an access to the physical blocks 1030-1034 during a subsequent read operation is replaced by an access to the physical blocks 1100-1104. This means that the recording/reproduction control device 30 reads the updated file. At this time, because the drive control device 25 performs alternate processing based on the physical addresses, the information indicating the logical address remains unchanged. This eliminates the need for the recording/reproduction control device 30 to perform special processing for the file system. Therefore, the size of the file system software in the recording/reproduction control device 30 can be reduced.

It should be understood that many modifications and adaptations of the invention will become apparent to those skilled in the art and it is intended to encompass such obvious modifications and changes in the scope of the claims appended hereto.

What is claimed is:

1. An optical recording medium comprising:
a user data area having a plurality of blocks in which optical recording data is recorded; and
a management area storing therein a recording management table including at least one of area allocation information and defect information, said area allocation information used for writing the optical recording data in said user data area, said defect information used for performing defect management processing in said user data area,
wherein said area allocation information includes at least type information indicating that the information is the allocation information, an allocated physical address indicating a start block of written information, a logical address of the user data area corresponding to the allocated physical address, and a length of the blocks in which the data is written and
the defect information includes at least type information indicating that the information is the defect information, a defective physical address indicating a start block of a defect, an alternate physical address that is an address used when an area indicated by the defective physical address is replaced by another area in the user data area, and a length of the blocks replaced by the alternate area.

2. A defect management device for an optical recording medium, comprising:
a temporary storage buffer unit temporarily recording therein a recording management table including at least one of area allocation information and defect information, said area allocation information used for writing optical recording data in a user data area having a plurality of blocks of an optical recording medium in which the optical recording data is recorded, said defect information used for performing defect management processing in said user data area;
a defect detection unit that detects a defect consisting of at least one defective block in said user data area on the optical recording medium;
a defect information creation unit that, when said defect detection unit detects the defect, creates, as the defect information, at least type information indicating that the information is the defect information, a defective physical address indicating a start block of the defect, an alternate physical address that is an address used when an area indicated by the defective physical address is replaced by another area in the user data area, and a length of the blocks replaced by the alternate area, and supplies the created defect information to said temporary storage buffer unit;
an allocation information creation unit that creates, as the area allocation information, at least type information indicating that the information is the allocation information, an allocated physical address indicating a start block of written information, a logical address of the user data area corresponding to the allocated physical address, and a length of the blocks in which the data is written, and supplies the created area allocation information to said temporary storage buffer unit;
a recording management table writing unit that writes the recording management table, temporarily stored in said temporary storage buffer unit, into the management area on the optical recording medium; and
a recording management table reading unit that reads a latest recording management table, written in the management area on the optical recording medium, and temporarily stores the recording management table into said temporary storage buffer unit.

3. A defect management method of managing a defect on an optical recording medium including a user data area having a plurality of blocks in which optical recording data is recorded, and a management area storing a record management table including at least one of area allocation information and defect information, said area allocation information used for writing data in said user data area, said defect information used for performing defect management processing in said user data area, the method comprising:
detecting a defect consisting of at least one defective block in said user data area on the optical recording medium;
reading the recording management table from the management area according to the detection of the defect;
storing the recording management table temporarily into a temporary storage buffer unit;
searching for another area for storing optical recording data recorded on an area corresponding to the defect in the user data area;
recording the optical recording data recorded on the area corresponding to the defect into the another area in the user data area;
creating, as the defect information, at least type information indicating that the information is the defect information, a defective physical address indicating a start block of the defect, an alternate physical address that is an address used when an area indicated by the defective physical address is replaced by the another area in the user data area, and a length of the blocks replaced by the alternate area;
updating the recording management table in said temporary storage buffer unit by adding the created defect information to the recording management table; and
recording the recording management table stored temporarily in said temporary storage buffer unit into the management area on the optical recording medium.
